(19) United States
(12) Patent Application Publication
(10) Pub. No.: US 2017/0063196 A1
(43) Pub. Date: Mar. 2, 2017

(54) HUBLESS WHEEL MOTOR

(71) Applicant: REAC AB, Amal (SE)

(72) Inventor: Carl Johan OLSSON, Amal (SE)

(21) Appl. No.: 15/308,080

(22) PCT Filed: Apr. 29, 2014
(86) PCT No.: PCT/EP2014/058717

§ 371 Date: Oct. 31, 2016

(51) Int. Cl. H02K 7/14; A61G 5/04; B60K 7/00; H02K 7/08; H02K 11/33

(52) U.S. Cl. CPC H02K 7/14; H02K 7/086; H02K 11/33; B60K 7/0007; A61G 5/042

(57) ABSTRACT

The present invention relates to a drive system for an electric vehicle comprising: a wheel rim, a bearing arrangement, a plurality of rotor elements circumferentially arranged along a circumference coaxial with a circumference of the wheel rim and fixated to the wheel rim adjacent to the bearing arrangement; and a plurality of stator elements circumferentially arranged along a circumference coaxial with the circumference of the rotor elements and spaced apart from the rotor elements, the stator elements are non-rotationally arranged to the non-rotating portion of the bearing arrangement, whereby an air gap in is formed between a stator element and a rotor element, wherein a first distance from the axis of rotation to the bearing arrangement is larger than a second distance from the air gap to the bearing arrangement.

### FIELD OF THE INVENTION

The present invention relates to a drive system for electric vehicles. In particular, the present invention relates to a drive system for electrically powered wheelchairs.

### BACKGROUND

Wheelchairs are important devices for people suffering from conditions which reduce their mobility capability. Therefore, wheelchairs may increase the quality of life for millions of people suffering from such conditions. The conditions may be caused by certain disabilities or obesity, or for example age.

More recently, electrically powered wheelchairs have become a more common solution for facilitating motion for affected persons, in particular persons suffering from more severe conditions. By enabling electrical power to drive the wheelchair the quality of life, in particular for severely affected people is even further improved since less manual operation of the wheelchair is required. For example, travelling longer distances is less exhausting with an electrically powered wheelchair compared to with a manually operated wheelchair. An electrical power system in a wheelchair also enables for sophisticated operations and functions, of the wheelchair, which may be electrically controlled and powered.

For powered wheelchairs, the drive system of the wheelchair is provided with electrical power by a battery pack mounted on the wheelchair. The electrical power is provided to an electrical motor of the drive system, typically a normal DC-motor. Most commonly, as part of the drive system, there is further a gearbox for speed and torque conversion from the electric motor. The gearbox and the battery pack are bulky, heavy, and relatively costly. Furthermore, for carrying the different parts related to the electrical drive system a robust chassis is required due to the weight and size of the drive system. For example, the wheelchairs disclosed by U.S. Pat. No. 6,154,690 and U.S. Pat. No. 5,351,774 are examples of powered wheelchairs suffering from at least some of the above drawbacks.

According to the above, it is desirable to obtain a less bulky drive system for an electrically powered wheelchair.

### SUMMARY OF THE INVENTION

In view of the above, it is a general object of the present invention to provide an integrated electric drive system for a vehicle such as a powered wheel chair.

The invention is defined in appended claim 1. Further preferred optional features thereof are defined in subsequent claims 2-15.

According to a first aspect of the inventive concept it is therefore provided a drive system for an electric vehicle comprising: a wheel rim having an inner circumference on an inner surface and an axis of rotation and configured to provide driving motion for the vehicle; a bearing arrangement comprising a non-rotating inner portion, the bearing arrangement being configured to enable rotation of the wheel rim with respect to the inner portion for providing the driving motion, the bearing arrangement being circumferentially arranged in contact with the inner surface of the wheel rim; a plurality of rotor elements circumferentially arranged along a circumference coaxial with the circumference of the wheel rim and fixated to the wheel rim adjacent to the bearing arrangement; and a plurality of stator elements circumferentially arranged along a circumference coaxial with the circumference of the rotor elements and spaced apart from the rotor elements, the stator elements are non-rotationally arranged to the non-rotating portion of the bearing arrangement, wherein an air gap is formed between a stator element and a rotor element, wherein a first distance from the axis of rotation to the bearing arrangement is larger than a second distance from the air gap to the bearing arrangement.

The present invention is based on the realization that the stator elements and the rotor elements are arranged such that a spacing, herein referred to as an “air gap” between the stator and rotor elements is close to the bearing arrangement. Generally, the air gap between the stator and rotor should be as small as possible in order to maintain a high efficiency in the motor. This requirement puts high demands on tolerances of the parts (e.g. stator, rotor, bearing, etc) and manufacturing of a drive system. Arranging for the air gap to be close to the bearing arrangement, an electric drive system with a large diameter electric motor comprising the rotor and stator elements may be achieved with reduced length of a tolerance chain for the requirements on the air gap. A tolerance chain is the chain of tolerances in a series of components. For example, if component A has a first tolerance, and component B has a second tolerance, and component B is dependent on component A, the tolerance chain is from component A to B. Thus, the longer the tolerance chains the harder (and more costly) it is to fulfill the tolerances of all the components in the tolerance chain. A tolerance is the accuracy of the final measures of a particular part, for example the outer diameter of a bearing arrangement may not deviate by more than a certain amount or percentage from a desired diameter. The air gap is advantageously formed between a rotor element and a stator core of a stator element. Moreover, the air gap may advantageously be formed in a radial direction of the wheel rim.

Accordingly, the invention provides an electric drive system which may be placed inside the wheel rim of the vehicle. In particular, in the inventive electric drive system the air gap (between the rotor and stator) is closer to the bearing arrangement compared to the distance from the bearing arrangement to the axis of rotation of the wheel rim (thus, the axis of rotation shared with the bearing arrangement). In other words, the diameter of the outer circumference of the bearing arrangement is at least 50% of the diameter of the circumferential air gap. The invention thus provides advantages related to e.g. the discussed tolerance chains, thereby enabling an efficient electric motor to be placed inside the wheel rim of a vehicle.

The air gap is naturally not limited to comprising only “air” but may comprise any gaseous medium, or be evacuated (i.e. a vacuum), as long as the rotor elements are spaced apart from the stator elements, with the air gap being from the stator core.

In accordance with the invention, a wheel rim has a substantially circular cross-section which means that the axis of rotation is through the centre of the circular cross-section of the wheel rim. The wheel rim provides for driving motion for a vehicle on which the wheel rim is arranged, by rotation of the wheel rim about the axis of rotation.

The non-rotating portion of the bearing arrangement may be arranged at the inner surface of the wheel rim comprising the inner circumference of the wheel rim and may substantially follow the inner circumference. In other words, a length of a circumference of the bearing arrangement is substantially the same as the length of the inner circumference of the wheel rim. The bearing arrangement is thus arranged to provide for the wheel rim to rotate about the axis of rotation.

A rotor element in accordance with the invention may be the element of an electric motor which moves with respect to a stator for providing output power. Consequently, the stator element is the static element of the electric motor. The rotor elements may be arranged and fixated to the wheel rim, which means that the rotor elements rotate with the wheel rim, thus the rotor elements are physically attached to the wheel rim. Furthermore, the stator elements are circumferentially arranged, coaxially with respect to the wheel rim, to the inner portion of the bearing arrangement. Thereby, an air gap appears between the stator core of the stator elements and the rotor elements. In case of an air gap in the radial direction, the air gap is obtained as the spacing from the stator core of a stator element to the rotor element located radially outwards from the stator element in a radial direction away from the axis of rotation. Furthermore, the air gap is circumferential, thus the air gap extends along a circumference formed by the stator elements and the rotor elements. Thereby, the rotor elements and the stator elements are not in direct contact with each other. The stator elements and the rotor elements are arranged in a similar manner as in a brushless configuration.

The rotor elements arranged adjacent to the bearing arrangement means that the rotor elements may be arranged along a circumference essentially parallel with the circumference of the bearing arrangement and close to the bearing arrangement, but not in contact with the bearing arrangement.

The stator elements are arranged along a circumference coaxial with the circumference of the rotor elements and spaced apart from the rotor elements in order to, when the wheel rim and thereby also the rotor elements rotate, the air gap between the rotor elements and the stator elements (the stator core) is kept constant.

The first distance is the distance from the bearing arrangement to the axis of rotation of the wheel rim. The first distance may be measured in a radial direction parallel to a radial direction of the wheel rim, thus the first distance may be the shortest distance from the axis of rotation to a point of the bearing arrangement. Preferably, the first distance is the distance from an outer circumference of the bearing arrangement to the axis of rotation. The second distance is the distance from the air gap to the bearing arrangement. The second distance may be measured as the shortest distance from a point in the air gap to a point in the bearing arrangement. The point in the bearing arrangement may be at the outer circumference of the bearing arrangement.

For exemplary purposes, in a traditional electric motor, assume the diameter of the stator/rotor is 50 cm and that the bearing is placed in the center of the circular exemplary motor. Assume further that the bearing has a diameter 10 cm. In order to keep the air gap between the rotor and the stator in this exemplary motor small, the tolerance on the bearing will be excessive. Consider, for example, a small movement at the bearing. Due to the large distance from the bearing to the air gap, in this case 20 centimeter in a radial direction of the bearing, a small movement of the bearing translates into a large movement at the 50 cm diameter where the air gap is located.

Thus, placing the bearing arrangement close to the air gap according to the invention is advantageous. Furthermore, another advantage of arranging the air gap close to the bearing arrangement is that an external influence on the drive system will affect the stator and rotor substantially equal, thus the air gap may not be critically compromised. An external influence may for example be an impact of a curb, or another vehicle.

According to at least one exemplary embodiment, the stator element may comprise a stator core, wherein the air gap is formed between the stator core and the rotor element. The stator core may be a solid core formed by a material having a high magnetic permeability. For example, a stator element may comprise a coil arranged around the solid core of a material having a high magnetic permeability.

According to at least one exemplary embodiment, the first distance may be five times larger than the second distance. Thereby, the tolerance demands of the drive system are improved further. Furthermore, a large diameter of the circumferential arrangement of the rotor and stator enables a high enough torque from the drive system which reduces the need for gears, thus the need for a gearbox is eliminated or at least relieved.

According to another embodiment of the invention, the first distance may be ten times larger than the second distance.

According to one embodiment of the invention, the contact between the bearing arrangement and the inner surface of the wheel rim may be formed by rolling elements of the bearing arrangement. Thus, the bearing arrangement may comprise rolling elements. The rolling elements may for example be spherical balls of a ball bearing arrangement. By arranging the rolling elements at the inner circumference of the wheel rim and in contact with the inner surface of the wheel rim a large diameter of the drive system is enabled, thus improved torque output of the stator and rotor arrangement (the electric motor) of the drive system. Furthermore, the rolling elements are in direct contact with the wheel rim such that the wheel rim may rotate about the axis of rotation by rolling on the rolling elements. The inner circumference of the wheel rim is along a surface of the wheel rim facing the axis of rotation at the centre of the wheel rim. Moreover, the inner portion of the bearing arrangement may be made from steel or any other suitable material. For example, the inner portion of the bearing arrangement may be made from aluminum and the rolling elements may be plastic. Plastic rolling element saves cost and lowers weight of the drive system. Due to a high number of rolling elements in the drive system, the plastic rolling elements may withstand the weight of the drive system and a weight of a vehicle comprising the drive system. Preferably, the second distance is the distance from the rolling elements to the air gap. In addition, the first distance is preferably the distance from the axis of rotation to the rolling elements of the bearing arrangement.

According to at least one exemplary embodiment, an outer diameter of the bearing arrangement may be substantially equal to an inner diameter of the wheel rim. Thus, the wheel rim is supported by the bearing arrangement. Preferably, the wheel rim may be supported by rolling elements of the bearing arrangement.

According to at least one exemplary embodiment, a cover member may be arranged to cover the rotor elements and the stator elements in a hollow space formed inside and coaxial with the wheel rim, wherein the cover member seals the wheel rim in the direction of the cover member. Since the bearing arrangement, the rotor elements, and the stator elements are arranged close to the circumference of the wheel rim, a hollow space, or a compartment, or an open space, is available in a radial direction of the wheel rim at a distance closer to the axis of rotation compared to the circumferential location of the stator elements. The cover member may be a form of lid or hubcap arranged to close the wheel rim in the axial direction, where the cover member is arranged. The cover member may be mounted with e.g. snap-in connection, screws, bolts, etc. The hollow space may be used for placing other components related to functions of the drive system. Preferably, but not necessarily, the cover member seals the wheel rim in a waterproof manner.

According to at least one exemplary embodiment, the hollow space may house an energy storage configured to provide power for operating the drive system. Energy storages for drive systems are generally large and bulky and require space. The compartment formed inside the wheel rim may advantageously be used for storing the energy storage such as a battery or several batteries. The energy storage may further provide power for the driving motion. Energy storage may be a battery comprising several battery cells such as a lithium-ion battery cells. Furthermore, the location of the battery in close proximity to the stator will also minimize need for high current wiring since all components involved in generating, driving and consuming high currents are in the same physical place.

According to at least one exemplary embodiment, the hollow space may house a control unit configured to control the drive system. The control unit may control e.g. the drive system and/or other related functions. Arranging the control unit in the compartment enables a even more compact drive system.

According to at least one exemplary embodiment, the stator elements are arranged on a non-rotating mounting arrangement. Thus, the stator elements are arranged separate from the rotor elements on a mounting arrangement such as a frame. The arrangement of the stator elements on the mounting arrangement further reduces the tolerance demand of the components of the drive system. Moreover, the mounting arrangement fixates the location of the stator elements. Furthermore, the non-rotating mounting arrangement is fixated to the non-rotating inner portion of the bearing arrangement.

According to at least one exemplary embodiment, the stator core of each of the stator elements is arranged on the non-rotating mounting arrangement. The stator core may advantageously be part of the mounting arrangement. In this way, the manufacturing of the drive system is facilitated by having fixed mounting positions for the stator elements ensuring a small air gap from the stator cores to the rotor elements. The stator core is advantageously a material having a high magnetic permeability.

As an example, the number of stator elements is at least five. The larger the number of stator elements (the number of poles in the drive system), the smaller a torque ripple gets. Thus, a higher number of stator elements enable a more comfortable drive experience for a user of the drive system.

Furthermore, in at least one example, each of the stator elements comprises a coil. A coil is a number of windings of conductive wire wound around a hollow core or around a solid core. The solid core is the stator core.

In several examples, the coils are arranged such that a central axis of the coils is pointing towards the axis of rotation of the wheel rim. This way, a magnetic field generated from the coils is efficiently coupled to the rotor elements.

According to at least one exemplary embodiment, a tire may be arranged circumferentially on the outside of the wheel rim. With a tire arranged on the wheel rim, using the wheel rim together with the tire for providing driving motion for a vehicle facilitated. A tire may be made from rubber or similar material appropriate for any conventional tire for driving outdoor and/or indoor.

According to a second aspect of the present invention, there is provided a powered wheelchair comprising the drive system according to the first aspect of the invention. In other words, the vehicle which is provided the driving motion is a powered wheelchair. The powered wheelchair thus uses electric power as an energy source for driving.

For example, the drive system is arranged as part of at least one wheel on the wheelchair for providing the driving motion. In other words, the drive system provides for both a wheel physically moving the wheelchair in a desired direction on the ground, and for an electric drive system providing the necessary power for rotating the wheel. Furthermore, the drive system enables for the energy storage and drive electronics to be placed in the compartment formed in the wheel rim, thus saving space for other equipment and/or for allowing other frames for supporting the wheelchair. Moreover, the drive system eliminates the need for a gearbox for the powered wheelchair due to the large diameter of the rotor and stator arrangement which provides for a high torque. In addition, due to the elimination of the gearbox, a user may operate the wheel manually, thus the wheel rolls freely in the drive system. Furthermore, a powered wheel chair may comprise two drive systems according to the invention. The two drive systems may be arranged as two main side wheels of the wheelchair. In other examples, the drive system may be arranged as rear wheels, front wheels, and/or supporting wheels.

Further effects and features of this second aspect of the present invention are largely analogous to those described above in connection with the first aspect of the invention.

Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF DRAWINGS

These and other aspects of the present invention will now be described in more detail, with reference to the appended drawings showing exemplary embodiments of the invention, wherein:

FIG. 1 schematically shows a wheelchair comprising a drive system according to an exemplary embodiment of the invention.

FIG. 2 shows a perspective cross-section of a drive system according to an exemplary embodiment of the invention;

FIG. 3 shows a cross-section of a part of the embodiment shown in FIG. 2;

FIG. 4 schematically shows a drive system according to an exemplary embodiment of the invention.

### DETAILED DESCRIPTION OF EMBODIMENTS OF THE INVENTION

In the following description, the present invention is mainly described with reference to a drive system for powered wheelchairs. However, it should be noted that the invention is equally applicable to other types of vehicles and is not limited to powered wheelchairs. Like reference numbers refer to like elements throughout.

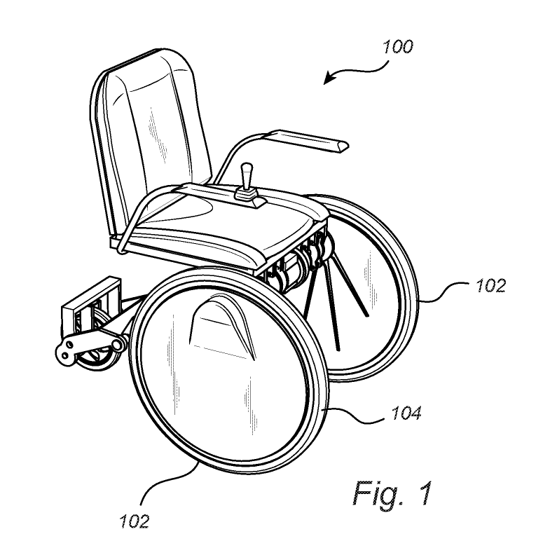

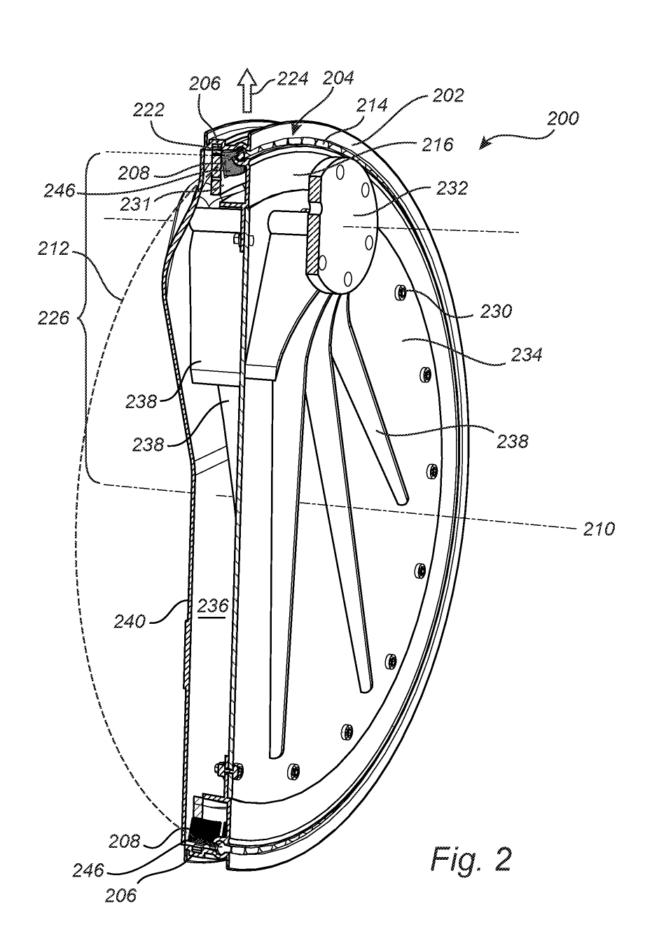

FIG. 1 illustrates an exemplary embodiment of the invention. FIG. 1 shows a powered wheelchair 100 comprising a drive system 102 according to an exemplary embodiment of the invention. Each of the drive systems 102 is arranged as a wheel of the powered wheelchair 100. By using the drive system 102 as a wheel, the required electronic components and energy storage is kept inside the wheel 102 (as will be shown with reference to FIGS. 2-4), thus the overall powered wheelchair 100 is less bulky compared to prior art powered wheelchairs. Furthermore, the drive system 102 has a large diameter meaning that the diameter of the rotor and stator arrangements is relatively large, providing for a large torque of the electric drive system 102, and thus eliminating the need for a gearbox. Moreover, the drive system 102 for the powered wheelchair 100 is a direct drive. Thereby, a rotatable part 104, comprising a tire, of the wheel 102 is allowed to rotate freely such that a user of the powered wheelchair 100 may operate the driving of the wheelchair 100 manually by hand if needed. The elimination of the gearbox and arranging the energy storage and drive electronics in the wheel enables a new design of the chassis for the wheelchair 100 compared to traditional wheelchair chassis.

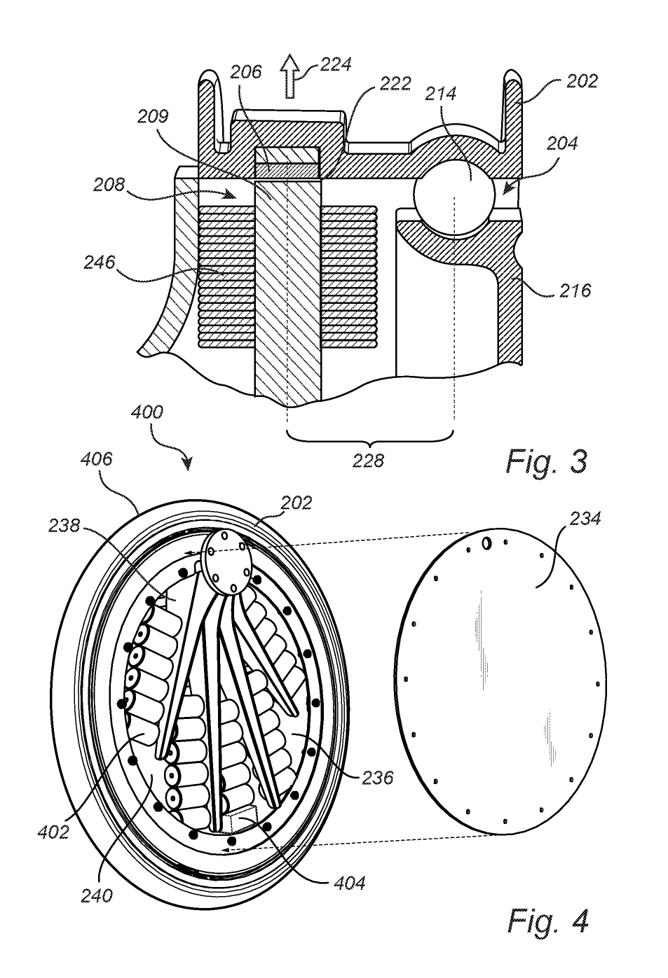

FIG. 2 shows a perspective cross-sectional view of an exemplary embodiment of the invention and FIG. 3 is a cross-section of a portion of the exemplary embodiment in FIG. 2. Now with reference to FIG. 2 and FIG. 3, there is shown a drive system 200 comprising a wheel rim 202, a bearing arrangement 204, rotor elements 206, and stator elements 208 (only one or the rotor elements and one of the stator elements are numbered in order to avoid cluttering in the drawing) each comprising a coil 246. The rotor elements 206 are preferably magnetic elements. In this way, no electrical connections are needed to the moving parts (e.g. rotor elements) of the drive system 200. The wheel rim 202 has an axis of rotation 210 about which the wheel rim 202 is configured to rotate when in use. A non-rotating inner portion 216 of the bearing arrangement 204 is arranged along the circumference 212 of the wheel rim 202 and in contact with the wheel rim 202 via rolling elements 214, in the form of spherical balls, of the bearing arrangement 204. Note that the bearing arrangement 204 is not limited to having ball elements but may comprise other such elements. With the bearing arrangement 204, the wheel rim 202 is rotatable with respect to the inner portion 216 of the bearing arrangement 204, thus the bearing arrangement 204 enables rotation of the wheel rim 202. The rotor elements 206 are circumferentially arranged along a circumference coaxial with the circumference 212 of the wheel rim 202. Furthermore, the rotor elements 206 are fixated to the wheel rim 202, adjacent to the bearing arrangement 204. The stator elements 208 are circumferentially arranged adjacent to the rotor elements 206 and coaxial with the circumference of the rotor elements 206, preferably along a circumferential with a smaller diameter than the circumference along which the rotor elements 206 are arranged. Thus, the stator elements 208 are arranged closer to the axis of rotation 210 compared to the rotor elements 206. Moreover, the stator elements 208 are arranged spaced apart from the rotor elements 206. Note that stator elements 208 and rotor elements 206 are arranged along the entire corresponding circumference, although in the drawing not all rotor and stator elements are shown. Thus, a plurality of stator elements 208 are coaxially arranged with respect to a plurality of rotor elements 206. As a result of the arrangement of the stator 208 and rotor elements 206, an air gap 222 is formed in the radial direction 224 from the stator core 209 (only shown in FIG. 3) of the stator elements 208 to the rotor elements 206. As depicted herein, most clearly seen in FIG. 3, the stator element 208 comprises a coil 246 mounted on a stator core 209. As shown in FIG. 3, the stator core 209 may extend outside the coil 246 in a direction towards the rotor element 206. However, other configurations are possible with e.g. the stator core 209 being arranged in-between two or more coils such that the stator core 209 is placed within (or in-between) the coils. Note that the air gap 222 here in FIG. 3 is depicted in the radial direction 224; however, the air gap 222 may in other configurations be formed in other directions without departing from the scope of the invention.

Preferably, the air gap 222 should be kept as small as possible as long as the rotor elements 206 and the stator elements 208 are not in physical contact. A typical air gap 222 is smaller than 1 mm, for example in the radial direction 224. The air gap 222 extends around the entire circumference of the arrangement of the rotor and stator elements 208. A first distance 226 is measured as the distance from the axis of rotation 210 of the wheel rim 202 to a point in the bearing arrangement 204 and a second distance 228 is measured as the distance from the air gap 222 to the bearing arrangement 204. The point in the air gap 222 from which second 228 distance is measured is preferably a center point of the air gap 222, and the point of the bearing arrangement 204 to which the first distance 226 and the second distance 228 are measured may be a center point of the bearing arrangement 204, here depicted as the center of a rolling element 214. However, the first 226 distance is larger than the second 228 distance. Preferably, the first 226 distance is twice the second distance 228, or five times larger, or ten times larger. In an exemplary embodiment, the air gap 222 between the rotor elements 206 and the stator elements 208 is approximately 0.5 mm, the width of the air gap is approximately 20 mm, the diameter of the circumferential air gap 222 is approximately 400 mm, the diameter of the wheel rim 202 is thereby close to 400 mm, and the second distance 228 is 25 mm. The second distance is normally between 5 millimeter and 50 millimeter, preferably smaller than 30 mm.

In FIG. 2 and FIG. 3, the rotor elements 206 are magnetic elements and the stator elements 208 each comprises a coil 246 arranged on a stator core 209. In operation, a modulation scheme of magnetic field generated by the coils 208 enables the rotor elements 206 to move by applying appropriate magnetic field pulses produced by the coil 246 to the rotor elements 206, thereby also moving the wheel rim 202. The modulation scheme may for example be a 3-phase scheme for a brushless electric motor. Preferably, the coils 246 are arranged such that a central axis of each coil is pointing towards the axis of rotation 210 of the wheel rim 202.

Again with reference to FIG. 2, the stator elements 208 are mounted on a non-rotating mounting 231 arrangement which is fixated with the inner portion 216 of the bearing arrangement 204. Moreover, a central plate 234 is fixated to the inner portion 216 of the bearing arrangement 204 by screws or bolts 230 (only one is numbered in order to avoid cluttering in the drawing). Furthermore, a hollow space 236 coaxial with the wheel rim 202 is formed between the central plate 234 and a cover member 240. In the hollow space 236, a plurality of support members 238 (only one is numbered in order to avoid cluttering in the drawing) is mounted on the central plate. The support members 238 and their function will be explained in more detail with reference to FIG. 4. For mounting of the drive system 200 as a wheel on a wheelchair chassis, a mounting element 232 is arranged on the side of the drive system 200. The drive system 200 may thus be mounted on a wheelchair using e.g. bolts.

FIG. 4 illustrates an embodiment of the present invention. In FIG. 4 a drive system 400 is shown similar to the drive system 200 as described with reference to FIG. 2. Furthermore, in the hollow space 236 formed in the center of the wheel rim 202, an energy storage 402 (only one is numbered in order to avoid cluttering in the drawing) and a control unit 404 are arranged. Preferably, the energy storage 402 and the control unit 404 are mounted on the support members 238. The hollow space 236 is provided between the central plate 234 and the cover member 240. The energy storage 402 is arranged to provide power to the stator elements 208, and the control unit 404 is configured to control the drive system 400, for example, the control unit 404 may provide a suitable pulse scheme for current provided to the stator elements 208 for enabling motion of the rotor elements 206 and thereby the wheel rim 202. In addition, a tire 406 is arranged around the circumference of the wheel rim 202, and circumferentially attached to the wheel rim on the outside of the circumference. By having a tire 406 mounted on the wheel rim, the drive system 400 may be used as a wheel for a vehicle driving both indoor and outdoor depending on the type of tire and the type of vehicle. Moreover, the support members 238 advantageously provide mechanical support for the drive system when operating as a wheel. For example, the support members provide efficient support for absorbing shear forces acting on the wheel rim 202.

Additionally, variations to the disclosed embodiments can be understood and effected by the skilled person in practicing the claimed invention, from a study of the drawings, the disclosure, and the appended claims. For example, the central plate, the cover member and the support members may be embodied in other variations than what is depicted in the exemplary embodiments. Furthermore, the mounting element may be configured differently as long as a proper mounting to a wheelchair is made possible.

In accordance with the invention a “control unit” is preferably a micro processor or any other type of computing device. Similarly, a computer readable medium, which may be part of or separate from the control unit and may be used for storing e.g. software for controlling various functions related to the drive system, may be any type of memory device, including one of a removable nonvolatile/volatile random access memory, a hard disk drive, a floppy disk, a CD-ROM, a DVD-ROM, a USB memory, an SD memory card, or a similar computer readable medium known in the art.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A drive system for an electric vehicle comprising:
a wheel rim having an inner circumference on an inner surface and an axis of rotation and configured to provide driving motion for said vehicle;
a bearing arrangement comprising a non-rotating inner portion, said bearing arrangement being configured to enable rotation of said wheel rim with respect to said non-rotating inner portion for providing the driving motion, said bearing arrangement being circumferentially arranged in contact with the inner surface of said wheel rim;
a plurality of rotor elements circumferentially arranged along a circumference coaxial with the circumference of said wheel rim and fixated to said wheel rim adjacent to said bearing arrangement; and
a plurality of stator elements circumferentially arranged along a circumference coaxial with the circumference of the rotor elements and spaced apart from said rotor elements, said stator elements are non-rotationally arranged to said non-rotating inner portion of said bearing arrangement,
wherein an air gap is formed between a stator element and a rotor element,
wherein a first distance from said axis of rotation to said bearing arrangement is larger than a second distance from said air gap to said bearing arrangement.

2. The drive system according to claim 1, wherein said stator element comprises a stator core, wherein said air gap is formed between said stator core and said rotor element.

3. The drive system according to claim 1, wherein said air gap is formed in a radial direction of said wheel rim.

4. The drive system according to claim 1, wherein said first distance is five times larger than said second distance.

5. The drive system according to claim 1, wherein said first distance is ten times larger than said second distance.

6. The drive system according to claim 1, wherein said contact between said bearing arrangement and said inner surface of said wheel rim is formed by rolling elements of said bearing arrangement.

7. The drive system according to claim 6, wherein said second distance is the distance from said rolling elements to said air gap.

8. The drive system according to claim 1, wherein an outer diameter of said bearing arrangement is substantially equal to an inner diameter of said wheel rim.

9. The drive system according to claim 1, wherein a cover member is arranged to cover said rotor elements and said stator elements in a hollow space formed inside and coaxial with said wheel rim, wherein said cover member seals the wheel rim in the direction of the cover member.

10. The drive system according to claim 9, wherein said hollow space houses an energy storage configured to provide power for operating said drive system.

11. The drive system according to claim 9, wherein said hollow space houses a control unit configured to control the drive system.

12. The drive system according to claim 1, wherein said plurality of stator elements are arranged on a non-rotating mounting arrangement.

13. The drive system according to claim 12, wherein the stator core of each of said stator elements is arranged on said non-rotating mounting arrangement.

14. The drive system according to claim 1, wherein a tire is arranged circumferentially on the outside of said wheel rim.

15. A powered wheelchair comprising the drive system according to claim 1.
